(19) United States
(12) Patent Application Publication
(10) Pub. No.: US 2021/0378457 A1
(43) Pub. Date: Dec. 9, 2021

(54) Vehicle Sanitizer Dispenser

(71) Applicant: Kevin Christensen, Murrieta, CA (US)

(72) Inventor: Kevin Christensen, Murrieta, CA (US)

(21) Appl. No.: 17/342,529

(22) Filed: Jun. 8, 2021

Related U.S. Application Data
(60) Provisional application No. 63/048,089, filed on Jul. 4, 2020.
(60) Provisional application No. 63/036,429, filed on Jun. 8, 2020.
(60) Provisional application No. 63/073,088, filed on Sep. 1, 2020.

(51) Int. Cl. A47K 5/12; B60R 15/02

(52) U.S. Cl. CPC A47K 5/1202; B60R 15/02

(57) ABSTRACT

A hand sanitizer dispenser having features to make it suitable for mounting on the exterior of a vehicle. The dispenser has a damage-resistant aerodynamic shape and can mount on windows, and on or in doors. The emitter enables use of the dispenser from outside of the vehicle. A door closes to seal the dispenser when it is not in use or when the vehicle is in motion. UV resistance and other weatherproofing features allow the dispenser container to provide protection for sanitizer containers. A locking cabinet makes the dispenser tamper and theft resistant.

### CROSS REFERENCE TO RELATED APPLICATIONS

The present invention claims the benefit of provisional patent applications: Ser. Nos. 63/036,429 filed Jun. 8, 2020; 63/048,089 filed Jul. 4, 2020; and 63/073,088 filed Sep. 1, 2020. Each provisional application is hereby incorporated by reference.

### FIELD OF INVENTION

The present invention generally relates to mechanisms for sanitizing hands before or after using a vehicle.

### BACKGROUND

Hand sanitizer has been in use, since as early as 1966, to clean hands when soap and water are not available. When used properly, modern hand sanitizers can eliminate up to 99.9% of germs on hands. Even prior to the coronavirus pandemic, many have recognized the value of the ability to clean or sanitize hands in work environments. According to a study published in 2007, it is estimated that U.S. employees miss up to 111 million workdays annually because of the flu, amounting to an estimated average of $16.3 billion in lost earnings each year. The 2017-2018 flu season reportedly caused more than 900,000 hospitalizations, 80,000 deaths and $21.39 billion dollars in losses from U.S. employers. These numbers are sobering and it is understood that a significant amount of germ transfer takes place in the work environment. As some work environments involve or require transportation, there is a benefit to establishing hand hygiene practices before and after operating a vehicle.

What is needed is a low profile vehicle mounted sanitizer dispenser that is conveniently located and operated, so as to facilitate frequent cleaning of hands and prevent the spread of disease.

### SUMMARY OF INVENTION

The present invention provides a hand sanitizer dispenser on the outside of a vehicle near the entrance, enabling a driver and/or passenger to be able to sanitize, disinfect, or otherwise clean their hands before entering the vehicle or after exiting the vehicle. The dispenser is sized and shaped to present a reduced profile that would not unduly increase wind resistance and that would reduce the likelihood of damage from debris. The dispenser is structured to protect the delivery mechanism from inadvertent activation. In particular, the dispenser may be integrated into a wind deflector, such as may be mounted on a vehicle door or window. Additionally, the dispenser may be recessed into a vehicle body panel.

### BRIEF DESCRIPTION OF DRAWINGS

FIG. 1 shows a sanitizer dispenser attached to the door of a truck.

FIG. 2 shows components of a sanitizer dispenser

FIG. 3 shows a sanitizer dispenser with open exterior casing.

FIG. 4 shows a sanitizer dispenser with closed exterior casing and panel.

FIG. 5 shows example mountain locations on a car.

FIG. 6 shows a wind deflector sanitizer dispenser on a second row side window of a pickup truck.

### DETAILED DESCRIPTION

An objective of the present invention is to provide a sanitizer dispenser that securely mounts in close proximity to the exterior entrance of a vehicle. A further objective of the present invention is to manage wind, debris, and other environmental factors that may be unique to the uncommon mounting choice. For the purposes of this disclosure, the term vehicle could be a car, truck, commercial vehicle, bus, tram, trailer, a recreational vehicle (RV), boat, train, or any form of vehicle that has motion and an entrance for a person.

The present invention improves upon previous efforts by providing a sanitizer dispenser assembly suitable for mounting on the outside of a vehicle near an occupant entrance. Multiple features disclosed herein work in concert to enhance this suitability. Important considerations in selecting an appropriate solution include: convenience, dispensing performance, safety, aesthetics, ease of maintenance, capacity, size/aerodynamics and durability. Occupant entrance is intended to suggest any door or passage through which a vehicle operator or passenger is intended to pass when using the vehicle.

There are many scenarios in which the inventive dispenser could be usefully applied. Police officers must frequently enter and exit their vehicles in order to interact with citizens, criminals, medical aids and contraband. A police cruiser has lights, cameras, push bars and many other useful tools attached to the vehicle. A conveniently located sanitizer dispenser would be especially welcome to reduce the exposure and transmission of germs and viruses encountered in first responder work. For some police vehicles, the most convenient placement may be toward the front of a rear-side window, high enough to not interfere with the window being rolled down. Other first responders could similarly benefit as the dispenser can be mounted just as well on fire trucks, ambulances and military vehicles.

Commercial and delivery service trucks in a wide variety of businesses would also be enhanced by the inventive dispenser. Drivers typically exit their vehicles to handle fuel pumps, deliver packages, sign forms and interact with others. Even vehicles that do not drive on public roads may benefit from the present invention. Such benefits may be extended to fork lifts, construction vehicles, golf carts and other vehicles—even those without doors.

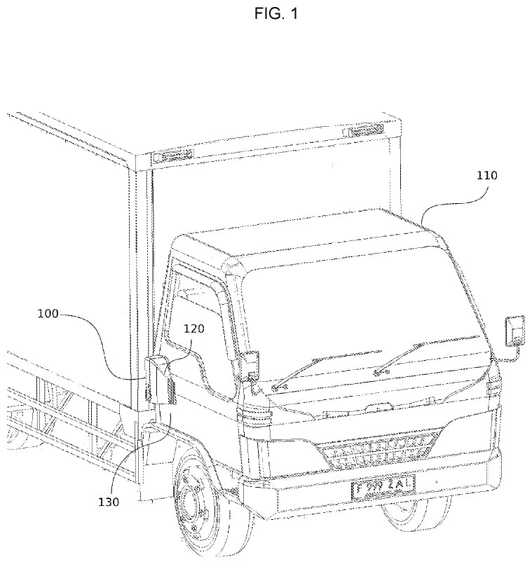

FIG. 1 shows an example of a sanitizer dispenser 100 mounted to the right-hand side door of a vehicle 110. It is understood that a dispenser 100 might be mounted on or near the driver's door, a passenger door or any vehicle entrance 130. In use, a driver or passenger can sanitize his or her hands by operating the dispenser 100 immediately before entering (or after exiting) the vehicle. As the vehicle 110 moves, an angled leading face 120 of the dispenser 100 may reduce aerodynamic drag and reduce the risk of damage from road debris.

RVs, both motorhomes and trailers, are essentially “moving homes” with kitchens, recreational and living quarters. These vehicles also would be enhanced by the aerodynamic “outdoor” hand sanitizer dispenser 100 securely mounted near the RV entrance door.

The feature set of the present invention enables secure and convenient mounting of the sanitizer dispenser near an entryway or exit for the vehicle. The mounting location is an important design consideration in the effectiveness of the hand sanitizer dispenser. For example, locating a hand sanitizer dispenser within the vehicle may require a driver to touch vehicle exterior surfaces, their key set, the seat, the door interior and even the steering wheel with untreated hands, potentially spreading germs before getting an opportunity to dispense the sanitizer. If the dispenser were, instead, mounted outside of the vehicle, secured and protected but far away from the entrance, the sanitizer would be protected but would be far less likely to be used and might therefore fail at its primary purpose. A design that properly manages these factors, enabling mounting where the sanitizer is most needed (whether on flat, convex or concave surfaces), provides benefits beyond those of other arrangements.

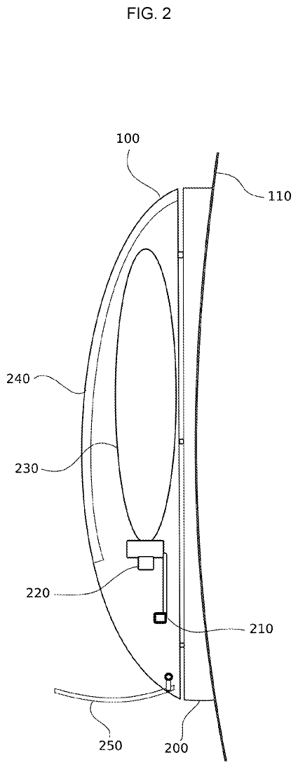

FIG. 2 shows an example of a dispenser 100, as disclosed, attached to a convex section of a vehicle 110 door. Here, a mounting interface 200 (also referred to as a connector) is shown accommodating the convex surface of the door and relatively flat back portion of the dispenser 100. As can be seen, the profile of the dispenser 100 is narrow. In this example, the dispenser 100 contains a sanitizer pouch 230 that holds the sanitizing fluid and conforms to the shape of the inside of the dispenser. An emitter or nozzle 220 enables the sanitizer to be dispensed upon activation of a pump or actuator 210 and a door (or shield or panel) 250 may be closed to substantially seal the dispenser 100 when it is not in use (especially when the vehicle is in motion). In the example shown, the door 250 opens by pivoting down and serving as a tray to catch any sanitizer that might drip from the nozzle 220. The sealing function of a door or panel 250 may enhance the aerodynamic properties of the dispenser (both to reduce drag and noise) and may also serve to help weatherproof the dispenser. Externally mounted dispensers are likely subject to environmental factors such as UV radiation, dust and temperature extremes. A closing panel 250 can help isolate the sanitizer pouch 230 and other internal components from these environmental factors. Additionally, insulation 240 may be applied to the inside or outside of the dispenser 100 to further isolate the dispenser internal components from the environment. Finally, the insulation 240 may also serve as a reinforcement to strengthen the leading surface, if required. The exterior surface may be treated with a film or paint to resist UV damage.

As has been mentioned, appropriate placement of a dispenser 100 provides both primary and secondary benefits. In a preferred embodiment, the dispenser is mounted on a tractor trailer cab, on a substantially flat surface just aft of an entrance door handle. By locating the dispenser in close proximity to a door handle 510, very little additional effort is required to sanitize hands prior to entering or subsequent to exiting the vehicle. Further, the appearance of the dispenser near a door handle 510 serves as a visual reminder, prompting the vehicle occupants to take a moment to clean their hands. In a preferred embodiment, the dispenser is located no more than two to four feet away from the door handle and on the same side of the vehicle to be considered within arms reach when entering or exiting the vehicle.

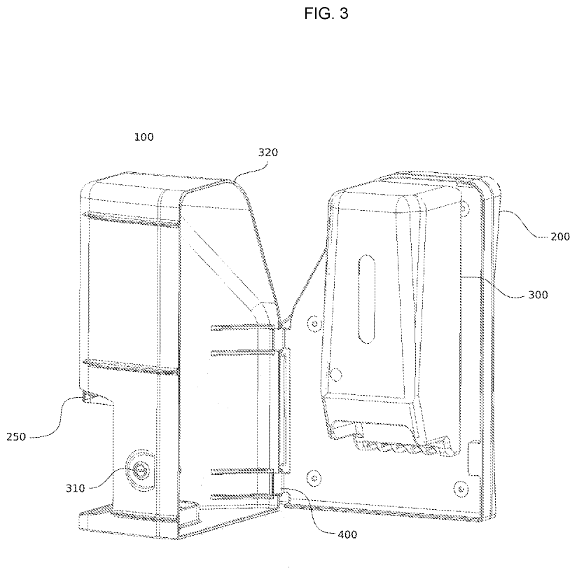

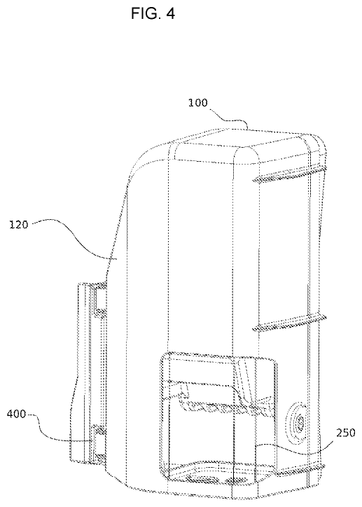

FIG. 3 shows an example dispenser 100 with a lockable clamshell design. This larger dispenser 100 might be suitable for mounting on a large vehicle such as an ambulance or the vehicle 110 shown in FIG. 1 (this one is designed for mounting on the left hand side). In this design, the large dispenser 100 contains a smaller dispenser 300 of a more conventional design (as might otherwise be mounted to a wall in a building). Here, the external casing 320 of the inventive dispenser provides environmental protection for the internal dispenser 300 and serves as an aerodynamic shroud. The mounting interface 200, again, enables the dispenser to be attached where it provides greater benefit. The sliding panel 250 enables access to the internal dispenser 300 and then closes to provide the internal components protection from the elements. A locking mechanism 310 is provided to make the assembly tamper and theft resistant. FIG. 4 provides a closed view of the dispenser 100 design shown in FIG. 3. In this view the dispenser casing has been closed and locked and the panel 250 has been closed as well. The angled leading surface 120 is visible near the casing's clamshell hinge 400.

Mounting Interface

One skilled in the art will appreciate that the dispenser may be attached to a vehicle in a number of temporary, semi-permanent and permanent ways via the mounting interface or connector 200. Adhesive (especially two-sided tape) may be used between the mounting surface of the dispenser and the body of the vehicle. Adhesive may also be used as part of a Velcro-style mounting solution, where the dispenser may be removed and reattached many times. Alternatively, as most vehicles are formed from a steel material, strong magnets may provide a more temporary mounting option, typically with a thin soft interface layer to prevent sliding or damage to the vehicle's finish. Suction cups may also be used as a more temporary mounting solution. Mechanical mounting options, such as screws and rivets, tend to be more permanent.

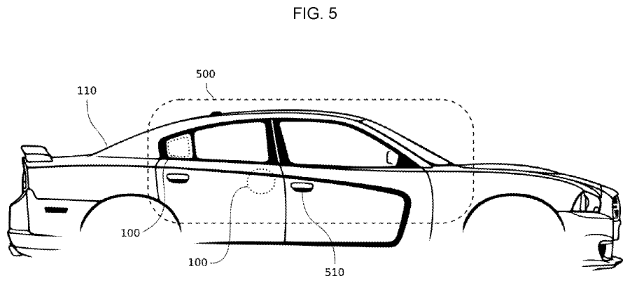

FIG. 5 shows a dotted outline of a region 500 surrounding a door handle 510. As it is desirable to locate the dispenser within arms reach of a door handle 510, certain front door, rear door, body panel and window locations 100 will be preferable for not requiring a driver or passenger to have to crouch/stoop or stretch. Two dispenser 100 locations are specified in FIG. 5. The one on the top left has been designed with a shape to fit over the quarter glass section at the rear window of a police vehicle. Notably, this area is large enough to accommodate a reasonably large reservoir of sanitizer, but would probably be too small to accommodate a useful volume of water. The second, is represented by a circular region just behind the passenger door handle 510. This dispenser 100 is mostly contained within the rear door, with only an emitter and sensor at the exterior surface. It is invisible at a distance.

In some installations, such as the embodiment shown in FIG. 1, mounting on the actual door 130 (rather than beside the door) may be preferred. As previously mentioned, a dispenser may also be mounted on a window as shown in FIG. 5. Windows are typically substantially flat and, being non-porous, are a great surface to attach to via suction cups. Because vehicle doors and other surfaces are often slightly convex (rather than completely planar), the dispenser mounting surface can be similarly curved to better conform to the shape of the door. Alternatively, an interface component can be provided to enable a dispenser having a planar mounting surface to be mounted to a non-planar door surface. Yet another alternative implementation uses a dispenser body formed from a semi-flexible material that deforms to fit flush against the shape of the surface to which it is mounted. Preferably, the body would have sufficient rigidity (at least toward its leading face) to resist deformation from airflow.

Preferably, the exterior surface of the dispenser has a low profile. This low profile or aerodynamic shape can help limit the additional drag caused by wind passing around the dispenser 100. Further, the reduced profile presents a smaller surface area for damage from debris. The leading surfaces may be angled so as to not present a face completely perpendicular to the axis of travel. Beyond reducing the aerodynamic drag, an angled surface 120 can reduce the stress to the dispenser when it is struck by an object as the vehicle is in motion. Finally, because aerodynamic shapes are more likely to be complimentary with the existing vehicle design aesthetics, an appropriately shaped dispenser may be preferable in the case of personal use vehicles.

In a preferred embodiment, the dispenser forms a shell around a sanitizer product, as shown in FIG. 3. The product may, itself, be contained within a bottle or a pouch, simplifying the procedure for refilling the dispenser. In such an embodiment, the dispenser may be opened to remove and insert a sanitizer product module. Such an opening may be enabled by a hinged connection 400 (preferably on the leading edge or at the top edge) between two portions of the dispenser. Alternatively, a portion of the dispenser exterior can be removed entirely for servicing and then fastened back into place for use. As previously mentioned, the dispenser may further be locked so that the sanitizer may not be tampered with. Such a lock might also be employed to prevent tampering or unauthorized dispensing.

In some embodiments of the present invention, the dispenser takes the form of a protective shell 320 substantially surrounding another dispenser 300 (such as those that may be used in a typical stationary installation) as shown in FIG. 3. The dispenser 100 of the present invention may provide a recess for the encased dispenser's nozzle in order to protect the encased dispenser from dirt, wind and other environmental factors. In such a case, the dispenser of the present invention would not necessarily include a separate nozzle of its own, but would still provide all of the benefits of the present, vehicle mounted, design (protection from environmental factors and convenient mounting, for example).

The dispenser 100 may be constructed of plastic, fiberglass, metal, or any other type of material suitable for securing the sanitizing product and attaching to the vehicle. Preferably, the dispenser would employ an ultraviolet radiation resistant material in its outer construction to prevent destruction by hours of intense sunlight. The leading surfaces of the dispenser may be reinforced with additional materials or structures to resist damage from airborne objects.

Sanitizer Considerations

Preferably, the sanitizer may take the form of a foam, a gel or a spray mist. One advantage provided by a mist is the reduced requirement to rub hands together in order to spread the sanitizer. This can be beneficial in situations where only one hand may be free. The composition of the sanitizer can vary according to the specifics of the application. Less flammable or non-flammable compositions may be used to reduce the risk of fire and, perhaps, to be more gentle for frequent use on hands. Alternatively, many alcohol-based sanitizers can be used for their quick drying effective cleaning properties.

The primary ingredient in many hand sanitizer products is alcohol, making complete freezing unlikely except in the most extreme of circumstances. Similarly, an alcohol based sanitizer is unlikely to combust unless exposed to unusually high temperatures. However, an alcohol based sanitizer may readily burn when exposed to a spark or flame. For this reason, preferred embodiments may employ a flame resistant layer in construction and may provide a shield (or door) 250 to any nozzle or port which may contain some product after use. Such a shield 250 could also serve to prevent the product from being dispensed, inadvertently, during travel by a vacuum created by the movement of air over the dispenser surface. Preferably, the shield would be retracted automatically prior to dispensing. In a preferred embodiment, the dispenser may include an insulative layer 240 (of foam, silicone or ceramic panels, for example) to help protect the sanitizer product from temperature extremes. This insulative layer could help preserve the sanitizer product, particularly when it is not alcohol-based, and can help protect other dispenser components from high temperatures. In the case of an ignition of sanitizer product, the insulative layer 240 may be used along with a flame resistant layer to prevent the fire and heat from spreading to the connected vehicle. In addition, the shield and insulative layer together may serve as weather protection for the dispenser, even in circumstances that do not demand heat or flame resistance.

The delivery mechanism 210 may be a manually operated pump, a passive gravity-powered flow value or even an electrically actuated pump or valve. Preferentially, in the case of electrically actuated pumps and/or valves, a sensor may be provided to detect the presence of a hand. Such a sensor may detect a hand via reflected sound waves (ultrasonic, for example), infrared, or one or more of many other known sensing mechanisms. Alternatively, the pump or actuator could be activated by a simple button press or touch to a screen, pad or other switching mechanism.

### Wind Deflector Embodiments

A dispenser 100 may be integrated into the body of a wind deflector, such as may be mounted on the door or window of a vehicle. Wind deflectors are often used to preserve some of the aerodynamic properties of a vehicle when the windows are open and to keep debris, rain and buffeting wind out of the cabin of the vehicle. By integrating a sanitizer dispenser into a wind deflector, benefits of a wind deflection system are combined with the benefits of an externally mounted sanitizer dispenser 100 without necessarily requiring anything further from the vehicle in terms of attachments or changes to the aesthetics. In addition, the deflecting function of the wind deflector may serve to satisfy many of the design goals of the vehicle sanitizer dispenser. For example, the dispenser nozzle may be shielded from the wind and the dispenser may also be shielded (by the deflector body) from dust and debris. Wind deflectors are typically designed with a low profile and constructed from a material that is resistant to damage from ultraviolet radiation. Wind deflectors are often tinted to reduce glare. The tinting can serve to obscure the dispenser componentry.

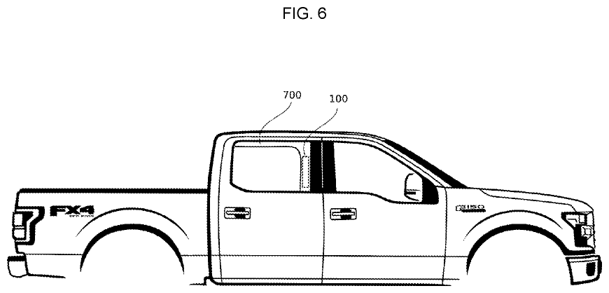

Typically, a wind deflector will follow the leading edge of the front side window and follow the curve of the window around to the top edge, ending at the rear edge of the window. Rear window wind deflectors generally span only the top edge of the rear side windows. For the purposes of the integrated hand sanitizer dispenser, a rear wind deflector 700 may also have coverage to apply to the leading edge of the rear window, as shown in FIG. 6. This placement may be ideal for some implementations of the sanitizer dispenser because it is so close to the front door of the vehicle and because it is less important that the rear window be kept free of visual obstructions. Preferably, the sanitizer reservoir and other dispenser componentry 100 would also be placed out of the line of sight (higher or lower, for example) to avoid unnecessarily interfering with the view from within the vehicle. The relatively long length of the window edges provides an opportunity to spread the reservoir and other components out, using significant volume without necessarily increasing the profile of the deflector dispenser 700.

Wind deflectors may be attached to a vehicle in a variety of ways. For example, “in-channel” deflectors may be installed into an upper window channel, sometimes with the addition of adhesive to better secure the attachment. Alternatively, a “stick-on” attachment may involve adhesive tape and enable installation at nearly any location.

### Recessed Embodiments

In a preferred embodiment, a dispenser may be located or mounted within a recessed portion (or orifice) of a vehicle body panel within arms reach of a vehicle entrance. The body panel may be a door or any other body panel. Preferably, the recess would be no more than 7 inches high and no more than 7 inches wide in order to preserve the general appearance and functional properties of the body panel. The recess may, but would not necessarily, extend all the way through the body panel. Ideally, the body panel would perform, structurally, at least as well as it would have without a recessed portion. Notably, structural features on body panels may actually increase rigidity. In preferred embodiments, the recess would be no more than 3 inches deep—deep enough to contain the necessary external dispenser components though not so deep that the recess interferes with functional space within the body panel. In some embodiments, a small opening (typically no more than a square inch) may be formed all the way through the body panel to enable passage of sanitizer dispenser components (a sanitizer tube, for example) all the way through the body panel.

In some embodiments, the sanitizer dispenser could be mounted to (or within) a door handle 510 assembly. This location enables the dispenser components to be hidden/disguised and also provides an especially convenient location for its operation as a person entering the vehicle will generally need to interact with the handle. Preferably, dispensers located on or about the door handle will benefit from touchless operation, which will permit a person to operate the dispenser before touching the handle, thus avoiding contamination of the handle surface. Another benefit of this type of integration is that it may allow older vehicles to support the recessed placement without requiring body panels to be replaced or modified. Designs that do not integrate the dispenser into the door handle may still be made to blend in with the overall design language of the vehicle by adopting similar looking hardware.

In fully recessed or flush mounted embodiments, it may not be necessary to provide shielding or aerodynamic shaping as the profile of the dispenser may be reduced simply by its recessed location.

I claim:

1. A dispenser comprising:
a fluid container;
an emitter, operable to release at least a portion of the contents from the fluid container upon activation; and
a connector, operable to secure said dispenser to a vehicle such that said dispenser is operable from the exterior of said vehicle, emitting fluid outside, within four feet of an occupant entrance to said vehicle.

2. The dispenser of claim 1, further comprising a panel operable to seal an exterior casing of dispenser when said dispenser is not in use.

3. The dispenser of claim 1, further comprising a low-profile exterior casing.

4. The dispenser of claim 1, further comprising a reinforced wall at the leading edge of said dispenser.

5. The dispenser of claim 1, further comprising a leading face offset at an angle from the plane perpendicular to the axis of forward vehicle travel.

6. The dispenser of claim wherein said fluid container is a dispensing device contained within said dispenser.

7. The dispenser of claim 1 wherein said fluid container is a replaceable reservoir.

8. The dispenser of claim 1 wherein said dispenser is set within a wind deflector.

9. The dispenser of claim 1 wherein said dispenser is inset within a vehicle body panel.

10. A vehicle comprising:
at least one entrance; and
a sanitizer dispenser mounted to the vehicle within four feet of said at least one entrance, the sanitizer dispenser comprising:
a fluid container;
an emitter, operable to release at least a portion of the contents from the fluid container upon activation; and
a connector, operable to secure said dispenser to the outside of a vehicle.

11. A dispenser comprising:
a fluid container;
a fluid emitter, operable to release at least a portion of the contents from said fluid container upon activation;
a vehicle body panel;
an orifice formed on the exterior surface of said vehicle body panel, said orifice being no taller than about 7 inches in height and no wider than about 7 inches in width;
a fluid emitter mounting point;
wherein said emitter is located substantially at said orifice; and
whereby said emitter is operable to transmit fluid from said fluid container onto the hands of a person located adjacent to an entrance to said vehicle.
